(19) United States
(12) Patent Application Publication
(10) Pub. No.: US 2008/0228752 A1
(43) Pub. Date: Sep. 18, 2008

(54) Technical correlation analysis method for evaluating patents

(75) Inventors: Chung-Jen Huang, Kaohsiung (TW); Alex Horng, Kaohsiung (TW)

Correspondence Address: Joe McKinney Muncy, PO Box 1364, Fairfax, VA, 22038-1364, US

(73) Assignee: Sunonwealth Electric Machine Industry Co., Ltd., Kaohsiung (TW)

(21) Appl. No.: 11/797,060

(22) Filed: Apr. 30, 2007

(30) Foreign Application Priority Data
Mar. 16, 2007 (TW) 096109052

(51) Int. Cl. G06F 17/30

(52) U.S. Cl. 707/5; 707/E17.008

(57) ABSTRACT

A technical correlation analysis method for evaluating patents includes the steps of: entering a technical term to determine a user-defined search, and to obtain a set of patent documents of search results; counting the number of times citing patent references in the patent documents, so as to generate a correlation index of the cited patent references; and ranking the patent references according to the correlation index of the cited patent references.

### BACKGROUND OF THE INVENTION

1. Field of the Invention

The present invention relates to a technical correlation analysis method for evaluating patents. More particularly, the present invention relates to the technical correlation analysis method of collecting and counting patent references cited in official patent offices for evaluating these patents.

2. Description of the Related Art

Currently, a patent search tool (e.g. patent database) provided in many official patent offices has applied a client/server model which can be searched by entering a key word (i.e. user's search term) such as a key word of title, a filing date, a patented date or an applicant name via connecting a user to a server. Accordingly, the user's search can be conducted and at least one patent document of search results may be generated. The patent document may include a patent publication document, a patent specification, a patent brief form or other related papers for reference.

The user can generally study the entire patent documents of search results via the patent database system. In addition to this, there is a need for the user to review technical correlations among these patent documents in the related art. For instance, the user can study the patent documents according to their cited references or technical objectives for professionally analyzing current technical problems and technical correlations. Accordingly, the user can realize new trends of technical research or long-existing technical problems in the art via such useful information of patents. The user such as a policy maker can also decide the strategy of research and evaluate the potential value of marketing according to such useful information of patents.

It is a common practice that the analyst must review each of the patent documents of search results for analyzing current technical problems of the related art and technical correlations among the patents within the user-defined search. Although such an analyzing method can be successful in studying the patent documents of the search results, there exist some other disadvantages.

With regard to the problematic aspects naturally occurring during processing the search results of patents, it takes a long time to gradually review or interpret each of the patent documents of the search results. This may result in a low efficiency of manpower and a waste of reviewing time. Another problem with reviewing each of the patent documents of search results is due to the fact that there exist a number of unrelated patents of search results. Hence, there is a need for improving such a conventional analyzing method for the patent documents of search results.

As is described in greater detail below, the present invention intends to provide a technical correlation analysis method for evaluating patents. The technical correlation analysis method includes the steps of: counting the number of times citing patent references in a patent database system depending upon a search result of a user-defined search; and ranking the patent references according to a correlation index of the cited patent references. This method is successful in reducing user-reviewing time and generating technical correlations among the cited patent references in such a way as to mitigate and overcome the above problem. For instance, the user can make a decision for the strategy of research and an evaluation for the potential value of marketing according to the correlation index of the cited patent references.

### SUMMARY OF THE INVENTION

The primary objective of this invention is to provide a technical correlation analysis method for evaluating patents, including the step of counting the number of times citing patent references within a user-defined search, so as to generate a correlation index of the cited patent references in a patent database system. Accordingly, this method is successful in reducing user-reviewing time and generating technical correlations among the cited patent references.

The secondary objective of this invention is to provide the technical correlation analysis method for evaluating patents, including the steps of counting the number of times citing patent references within a user-defined search and ranking the patent references according to a correlation index of the cited patent references. Accordingly, the user can rapidly receive the correlation index of the cited patent references within the scope of the user-defined search.

Another objective of this invention is to provide the technical correlation analysis method for evaluating patents, which is implemented by using a computer system to access a patent database system. Accordingly, this method can easily evaluate the patent references cited in patents of search results.

The technical correlation analysis method in accordance with an aspect of the present invention includes the steps of: entering a technical term to determine a user-defined search, and to obtain or retrieve a set of patent documents of search results; counting the number of times citing patent references in the patent documents, so as to generate a correlation index of the cited patent references; and ranking the patent references according to the correlation index of the cited patent references.

In a further aspect of the present invention, the technical correlation analysis method further includes the step of comparing cited patent references with patent documents of search results.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a flow chart illustrating a technical correlation analysis method for evaluating patents in accordance with a first embodiment of the present invention;

FIG. 2 is a schematic view illustrating the technical correlation analysis method for evaluating patents in accordance with the first embodiment of the present invention, depicting the step of searching patent and patent documents of search results;

FIG. 3 is a schematic view illustrating a statistic table of patent references generated in the second step of technical correlation analysis method in accordance with the first embodiment of the present invention;

FIG. 4 is a chart illustrating a correlation index diagram of patent references generated in the third step of technical correlation analysis method in accordance with the first embodiment of the present invention; and

FIG. 5 is a flow chart illustrating a technical correlation analysis method for evaluating patents in accordance with a second embodiment of the present invention.

### DETAILED DESCRIPTION OF THE INVENTION

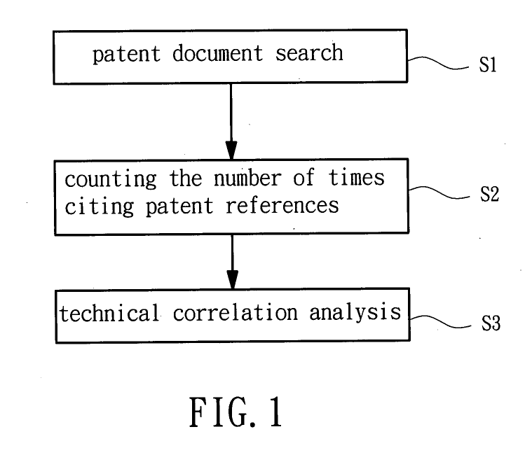

Referring now to FIG. 1, a technical correlation analysis method for evaluating patents in accordance with a first embodiment of the present invention includes the steps of: patent document search designated as step “S1”; counting citing weights of patent references designated as step “S2”; technical correlation analysis designated as step “S3”. In step “S1”, a user can enter a technical term or a desired keyword (i.e. a piece of undocumented or unstructured information) to determine a user-defined search, and to obtain a set of patent documents of search results with at least one patent reference. In step “S2”, the number of times citing patent references in the patent documents is counted so as to generate a correlation index of the cited patent references. In step “S3”, the correlation index of the cited patent references are generated and the patent references are ranked according to the correlation index.

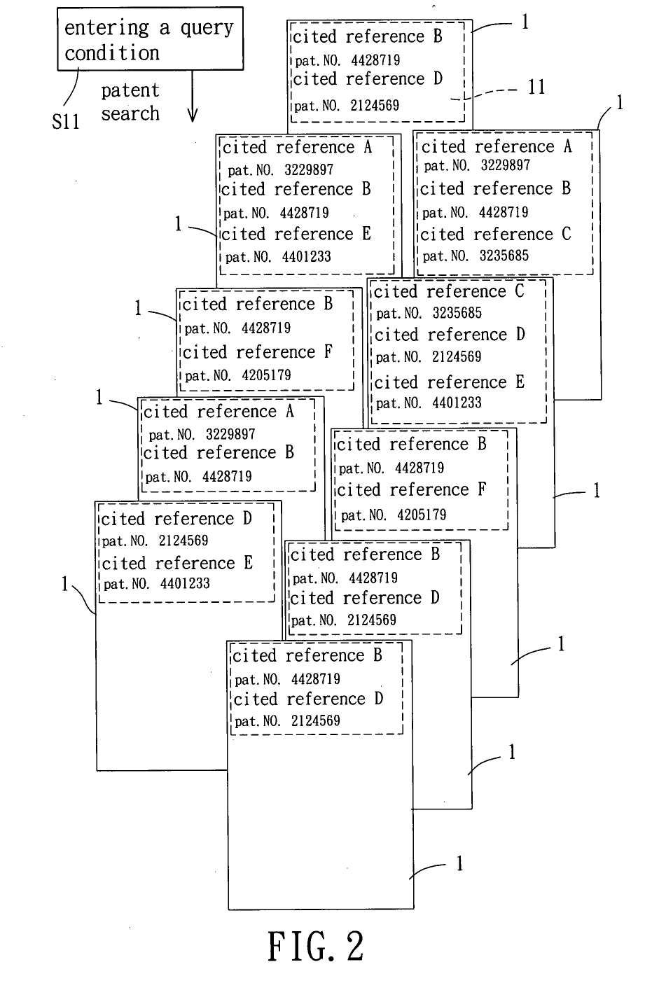

Turning now to FIGS. 1 and 2, the technical correlation analysis method in accordance with the first embodiment of the present invention is implemented by executing the step “S1” of patent document search. A user can enter a query condition of technical terms, as indicated in the block “S11” in FIG. 2. For example, when the user process a user-defined search for technical research or problems long-existing in the fan motor field, the query condition can be selected from keywords of fan motor components (i.e. fan motor elements). By way of example, the user can preferably link a computer device or the like to a patent database system which may be provided in a web page of United States Patent & Trademark (USPTO) for patent search, so as to obtain search results of patent documents 1 matching for the user-defined search. A front page of the U.S. patent document 1 listed in the search results includes a column (designated numeral 11) of References Cited and a list of patent references which are searched and cited by U.S. patent examiners during examination. However, each of the U.S. patent documents 1 may includes at least one patent reference cited in the examination procedure.

In step “S1”, with continued reference to FIGS. 1 and 2, for example, the “References Cited” column of a U.S. patent document displays the information of patent numbers, issued dates, inventors and international classifications which are searched and cited by U.S. patent examiners during examination. The patent database system (not shown) is used to collect the information of patent references (e.g. patent numbers listed in cited references of U.S. patent documents 1). In this embodiment, the search results may be a number of the patent documents 1 which contain a set of cited patent references identified as “A”, “B”, “C”, “D”, “E” and “F” for example. The cited patent references “A”, “B”, “C”, “D”, “E”, “F” may include some of the parent patent documents of search results. Subsequently, the technical correlation analysis method can execute the next step “S2” of counting the number of times citing. patent references if these patent references are collected.

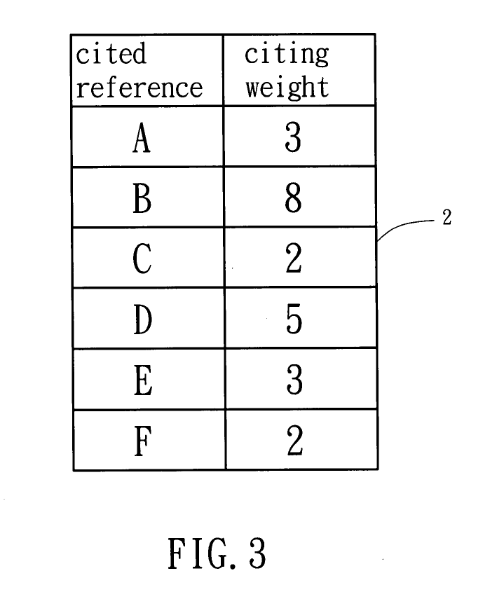

Turning now to FIGS. 1 through 3, the technical correlation analysis method in accordance with the first embodiment of the present invention is implemented by further executing the step “S2” of counting citing weights of patent references. In step “S2”, the user can employ a computer device (not shown) to calculate times of citing the patent references “A”, “B”, “C”, “D”, “E”, “F” in each of the patent documents 1 of search results for counting their weights. For example, the weight of patent reference “A” can be assigned numeral “3” after counting it three times. Accordingly, the weights of other patent references “B”, “C”, ” “E”, “F” can be correspondingly assigned numerals “8”, “2”, “5”, “3”, “2” once counted. Preferably, the weights of the cited patent references “A”, “B”, “C”, “D”, “E”, “F” are shown in a statistic table 2 or an equivalent table, as best shown in FIG. 3, and appears the technical correlation among the patent documents 1 of the previous search results. The user can only require reviewing the weights of the cited patent references “A”, “B”, “C“1, “D”, “E”, “F” to analyze the previous search results without the need of reviewing each of the patent documents 1.

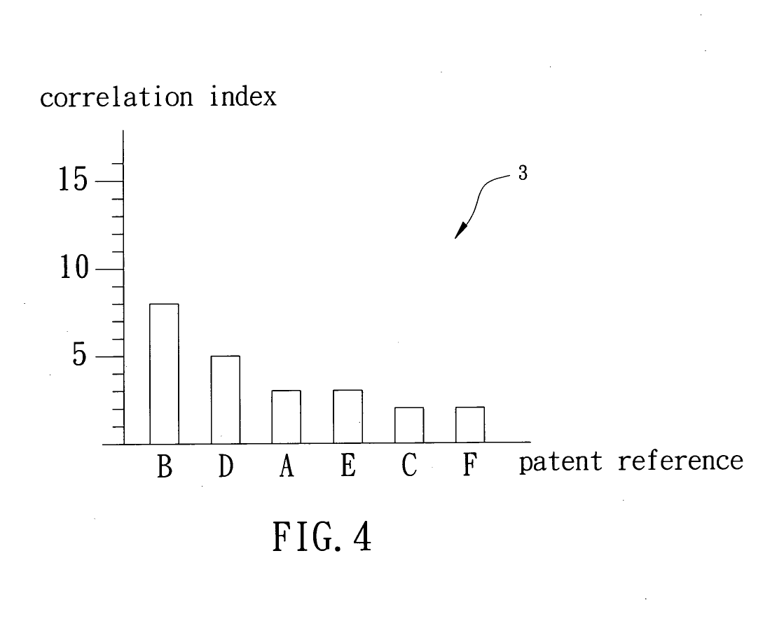

Turning now to FIGS. 1 through 4, the technical correlation analysis method in accordance with the first embodiment of the present invention is implemented by further executing the step “S3” of technical correlation analysis. The user can operate the computer device to automatically rank the cited patent references “A”, “B”, “C”, “D”, “E”, “F” according to their weights of “3”, “8”, “2”, “5”, “3”, “2”. In a preferred embodiment, the cited patent references “A”, “B”, “C”, “D”, “E”, “F” may be ranked in a manner of progressive increase or decrease according to their weights. Preferably, a stick diagram or a statistic chart is utilized to display the results of the ranked patent references “A”, “B”, “C”, “D”, “E”, “F” according to their weights of “3”, “8”, “2”, “5”, “3”, “2”, as best shown in FIG. 4. In FIG. 4, the X-axis represents values of the ranked patent references “A”, “B”, “C”, “D”, “E”, “F”, and the Y-axis represents values of weights of “3”, “8”, “2”, “5”, “3”, “2” as correlation index. It will be understood that a higher value of the weight appears a greater correlation of common practice or technical problems in the art.

Referring back to FIGS. 1 and 2, the steps “S1” to “S3” of the technical correlation analysis method in accordance with the first embodiment of the present invention can be implemented by the computer device (not shown) or other equivalent devices. Preferably, the computer device includes a display interface (not shown) to link a patent database system (not shown) for automatically executing the steps “S1” to “S3” of the technical correlation analysis method. The user can store the analysis results generated by the technical correlation analysis method in a database system (not shown) and can update the analysis results by repeatedly executing the steps “S1” to “S3” of the technical correlation analysis method, so as to provide a professional analyst (e.g. high-level executive) for review. The display interface is used to display the analysis results of the patent documents. The analysis results of the patent references are converted into computer data to produce a drawing or a table showing in the display interface if desired.

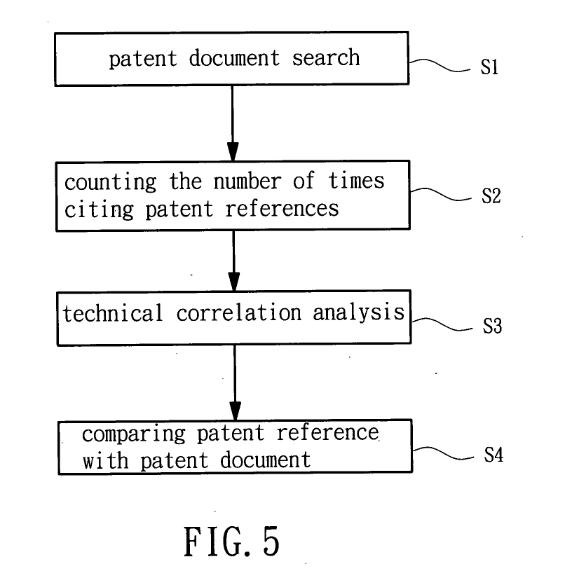

Turning now to FIG. 5, a flow chart illustrating a technical correlation analysis method for evaluating patents in accordance with a second embodiment of the present invention is illustrated. In comparison with the first embodiment, the technical correlation analysis of the second embodiment further includes the step of: comparing cited patent references with patent documents of search results designated as step “S4”. In step “S4”, patent numbers of the cited patent references are compared with those of the patent documents 1 of search results which are generated in the previous step “S1”. Accordingly, the user can review any correlation between the cited patent references and the patent documents 1.

Referring back to FIGS. 2 and 4, for instance, the two patent references “B” and “D” assigned to the higher weights “8” and “5” are designated to compare with the patent documents 1. The qualified patent document 1 will be recognized to possess a higher correlation in the user-defined search if the patent number of the patent references with higher weight (e.g. weights “8” or “5”) matches for that of the patent document 1 listed in the search results. Accordingly, the qualified patent documents 1 will be assigned and noticed as higher priority patent documents.

As has been discussed above, in the past, it takes a long time for the user to gradually review or interpret each of the patent documents of the search results. The user cannot rapidly find out which patent document of search results should be placed at a top priority for review. Conversely, the technical correlation analysis method in accordance with the present invention includes the step “S2” of counting the number of times citing patent references in the patent documents 1 so as to generate a correlation index of the cited patent references, and the step “S3” of ranking the patent references according to the correlation index, as best shown in FIG. 1. The technical correlation analysis method further includes the step “S4” of cormparing cited patent references with patent documents of search results, as best shown in FIG. 5. Accordingly, the user can conduct the user-defined search and can rapidly find out which patent should be placed at a top priority for review.

Although the invention has been described in detail with reference to its presently preferred embodiment, it will be understood by one of ordinary skill in the art that various modifications can be made without departing from the spirit and the scope of the invention, as set forth in the appended claims.

What is claimed is:

1. A technical correlation analysis method for evaluating patents, comprising the steps of:
retrieving a set of patent documents of search results;
counting the number of times citing patent references in the patent documents, so as to generate a correlation index of the cited patent references; and
ranking the patent references according to the correlation index of the cited patent references.

2. The technical correlation analysis method for evaluating patents as defined in claim 1, further comprising the step of: comparing a patent number of the cited patent references with those of the patent documents of the search results.

3. The technical correlation analysis method for evaluating patents as defined in claim 1, wherein a computer device is used to execute the steps.

4. The technical correlation analysis method for evaluating patents as defined in claim 3, wherein the computer device includes a display interface to link a patent database system, so as to store analysis results of the patent references in the database system and to display the analysis results on the display interface.

5. The technical correlation analysis method for evaluating patents as defined in claim 1, wherein the patent documents are selected from U.S. patent documents.

6. The technical correlation analysis method for evaluating patents as defined in claim 1, wherein analysis results of the patent references are converted into computer data.

7. The technical correlation analysis method for evaluating patents as defined in claim 6, wherein the computer data of the analysis results are used to produce a drawing.

8. The technical correlation analysis method for evaluating patents as defined in claim 6, wherein the computer data of the analysis results are used to produce a table.

9. The technical correlation analysis method for evaluating patents as defined in claim 1, wherein the cited patent references are ranked in a manner of progressive increase according to their weights of counting the number of citing the patent references.

10. The technical correlation analysis method for evaluating patents as defined in claim 1, wherein the cited patent references are ranked in a manner of progressive decrease according to their weights of counting the number of citing the patent references.
